(19) United States
(12) Patent Application Publication
(10) Pub. No.: US 2009/0304292 A1
(43) Pub. Date: Dec. 10, 2009

(54) ENCODING AND DECODING METHODS, DEVICES IMPLEMENTING SAID METHODS AND BITSTREAM

(75) Inventors: Quqing Chen, Beijing (CN); Zhibo Chen, Beijing (CN); Xiaodong Gu, Beijing (CN)

Correspondence Address: Thomson Licensing LLC, P.O. Box 5312, Two Independence Way, PRINCETON, NJ, 08543-5312, US

(73) Assignee: THOMSON LICENSING CORPORATION

(21) Appl. No.: 12/309,721

(22) PCT Filed: Aug. 4, 2006
(86) PCT No.: PCT/CN2006/001963

§ 371 Date: Jul. 20, 2009

(51) Int. Cl. G06K 9/36

(52) U.S. Cl. 382/233; 382/246

(57) ABSTRACT

The invention relates to a method for encoding a plurality of non overlapping blocks in a picture. The method comprises the steps of:
transforming each of the blocks into a transformed block of coefficients in the frequency domain by applying a predefined transform;
scanning the coefficients of at least two neighboring transformed blocks jointly from the lowest frequency to the highest frequency according to a predefined scanning pattern, the group of at least two neighboring transformed blocks being called super-block; and
entropy coding the scanned coefficients of the super-block into an entropy coded group of bits.

### 1. FIELD OF THE INVENTION

The invention relates to a method for encoding a sequence of pictures. It also relates to the encoding device implementing this method.

### 2. BACKGROUND OF THE INVENTION

Most of the methods for encoding a sequence of pictures divided in non overlapping blocks of pixels comprise the following steps, for each block:

transforming the block into a transformed block of coefficients by applying a predefined transform;

scanning the coefficients of the transformed block according to a zig-zag pattern; and

entropy coding the scanned coefficients of the transformed block into an entropy coded group of bits.

The transforming step is often preceded by a prediction step. After the prediction step, the blocks of residuals are transformed into transformed blocks of coefficients usually by applying a DCT (discrete cosine transform) or a simplified integer transform. While the residuals are in the spatial domain, the coefficients are in the frequency domain. The transforming step is often followed by a quantization step in order to get blocks of quantized coefficients. The quantized coefficients are then entropy coded to further remove the statistical redundancy within the coefficients. In the sequel, the words “transformed block” means either a block that has been simply transformed or a block that has been transformed and quantized. The coefficients of each transformed block are usually scanned before entropy coding according to a zig-zag pattern as depicted on FIG. 1 for one block of 4 by 4 coefficients. According to this scanning pattern low frequency coefficients which have higher energy are scanned first while coefficients with lower energy, i.e. high frequency coefficients are scanned last. The zig-zag pattern thus rearranges the coefficients within a transformed block in a list of coefficients from up-left coefficients to bottom-right coefficients. The entropy coding step benefits from this scanning pattern since, statistically, more zero coefficients are located at the end of the list and are therefore not coded.

### 3. SUMMARY OF THE INVENTION

The invention relates to a method for encoding a plurality of non overlapping blocks in a picture. The method comprises the steps of:

transforming each of the blocks into a transformed block of coefficients in the frequency domain by applying a predefined transform;

scanning the coefficients across at least two neighboring transformed blocks from the lowest frequency to the highest frequency according to a predefined scanning pattern, the group of two neighboring transformed blocks being called super-block; and

entropy coding the scanned coefficients of the super-block into an entropy coded group of bits.

Advantageously, the encoding method allows to save bits when encoding a given sequence of pictures by scanning the coefficients more efficiently. More particularly, by scanning coefficients across multiple transformed blocks more statistical redundancy is removed.

According to one embodiment, the predefined transform applied to each block of the super-block is such that the lowest frequency coefficients are located in the center of the super-block while the highest frequency coefficients are located on the outer side of the super-block.

According to another embodiment, the same predefined transform is applied to each block of the super-block and the transforming step is followed by a transposing step for rearranging the coefficients within the super-block so that the lowest frequency coefficients are located in the center of the super-block while the highest frequency coefficients are located on the outer side of the super-block.

According to a specific characteristic, the scanning pattern is a spiral pattern. According to other characteristics, the predefined transform is a discrete cosinus transform and the super-block is made up of two lines of two blocks.

The invention also relates to a device for encoding a sequence of pictures divided into non overlapping blocks comprising:

means for transforming each of the blocks into a transformed block of coefficients in the frequency domain by applying a predefined transform;

means for scanning the coefficients; and

entropy coding means for encoding the scanned coefficients into an entropy coded group of bits.

According to one embodiment, the scanning means are adapted to scan the coefficients across at least two neighboring transformed blocks from the lowest frequency to the highest frequency according to a predefined scanning pattern.

The invention concerns a bitstream of MPEG type. According to a first embodiment, the bitstream comprises at least one bit indicating whether the size of the predefined scanning pattern used for the encoding of at least a portion of an image is larger than the size of a transformed block or whether the size of the predefined scanning pattern equals the size of a transformed block. According to another embodiment, the bitstream comprises at least one bit indicating whether the size of the predefined scanning pattern used for the encoding of a group of images is larger than the size of a transformed block or whether the size of the predefined scanning pattern equals the size of the transformed block.

### 4. BRIEF DESCRIPTION OF THE DRAWINGS

Other features and advantages of the invention will appear with the following description of some of its embodiments, this description being made in connection with the drawings in which:

FIG. 1 depicts a scanning pattern for a block of 4 by 4 pixels according to the state of art;

FIG. 2 depicts a super-block made up of two lines of two blocks of 4 by 4 pixels;

FIG. 3 depicts the transposition of a top left 4 by 4 pixels block of a super-block made up of two lines of two blocks of 4 by 4 pixels according to the invention;

FIG. 4 depicts the transposition of a top right 4 by 4 pixels block of a super-block made up of two lines of two blocks of 4 by 4 pixels according to the invention;

FIG. 5 depicts the transposition of a bottom left 4 by 4 pixels block of a super-block made up of two lines of two blocks of 4 by 4 pixels according to the invention;

FIG. 6 depicts a super-block whose coefficients have been rearranged according to the invention;

FIG. 7 depicts a first spiral like scanning pattern according to the invention;

FIG. 8 depicts a second spiral like scanning pattern according to the invention;

FIG. 9 depicts a third spiral like scanning pattern according to the invention;

FIG. 10 depicts a fourth spiral like scanning pattern according to the invention; and

FIG. 11 depicts a fifth spiral like scanning pattern according to the invention;

FIG. 12 depicts a sixth spiral like scanning pattern according to the invention;

FIG. 13 depicts a seventh spiral like scanning pattern according to the invention;

FIG. 14 depicts an eighth spiral like scanning pattern according to the invention;

FIG. 15 depicts a scanning pattern according to the invention;

FIG. 16 depicts a flowchart of an encoding method according to a first embodiment of the invention;

FIG. 17 depicts a flowchart of an encoding method according to a second embodiment of the invention;

FIG. 18 depicts a flowchart of an encoding method according to a third embodiment of the invention;

FIG. 19 depicts a flowchart of a decoding method according to one embodiment of the invention;

FIG. 20 depicts an encoding device according to the invention; and

FIG. 21 depicts a decoding device according to the invention.

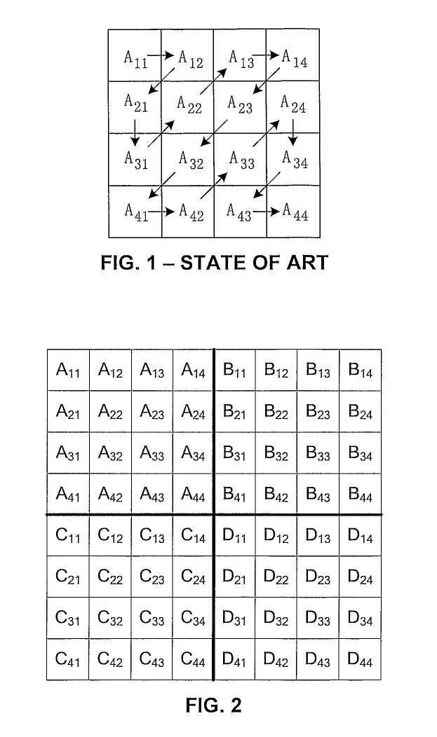

### 5. DETAILED DESCRIPTION OF PREFERRED EMBODIMENTS

In MPEG-2 video coding standard, the transforming step is applied to each block of 8 by 8 pixels and the entropy coding step is then applied to each transformed block of 8 by 8 coefficients. In H.264/AVC baseline profile, main profile and extended profile, the transforming step is applied to each block of 4 by 4 pixels and the entropy coding step is then applied to each transformed block of 4 by 4 coefficients. These encoding methods separate the statistical correlation between different neighboring transformed blocks and hence limit a further improvement of the coding efficiency of the entropy coding step.

To this aim, according to the invention, the entropy coding step is performed on a super-block made up of least two neighboring transformed blocks. Therefore, the entropy coding step is improved and so the compression efficiency. The coefficients are therefore scanned across transformed blocks as depicted on FIGS. 7 to 14 for four neighboring transformed blocks A, B, C and D. In the following detailed description of the embodiments, reference is made to the accompanying drawings that show, by way of illustration, specific embodiments in which the invention may be practiced. On these figures similar elements (steps or modules) are given the same reference numbers.

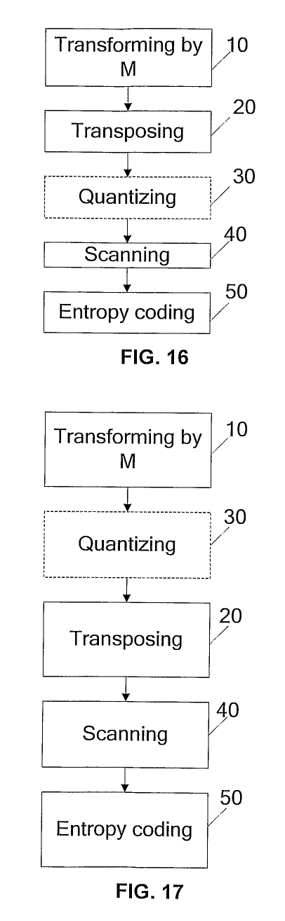

According to a preferred embodiment, the method depicted on FIG. 16 comprises the following steps, applied to a super-block:

transforming 10 each of the blocks of the super-block into a transformed block of coefficients in the frequency domain by applying a predefined transform M;

transposing 20 each of the blocks of coefficients if needed so that the lowest frequency coefficients are gathered in the center of the super-block while the highest frequency coefficients are located on the outer side of the super-block; and

scanning 40 the coefficients of said super-block according to a spiral pattern as depicted on FIG. 7 starting from the center of the super-block with the lowest frequency coefficients to the outer side of the super-block with the highest frequency coefficients; and

entropy coding 50 the scanned coefficients of said super-block into an entropy coded group of bits.

A quantization step 30, if any, is applied after the transposing step as depicted on FIG. 16 or before the transposing step as depicted on FIG. 17.

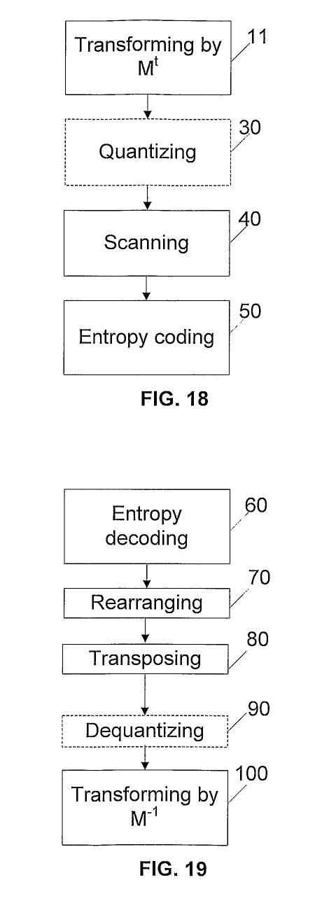

According to another embodiment depicted on FIG. 18, each block of the super-block are transformed and transposed in a single step 11 by applying directly to each block a dedicated transposed transform Mt so that the generated coefficients are located directly at the right place in the super-block according to FIG. 7, i.e. so that the lowest frequency coefficients are gathered in the center of the super-block while the highest frequency coefficients are located on the outer side of the super-block.

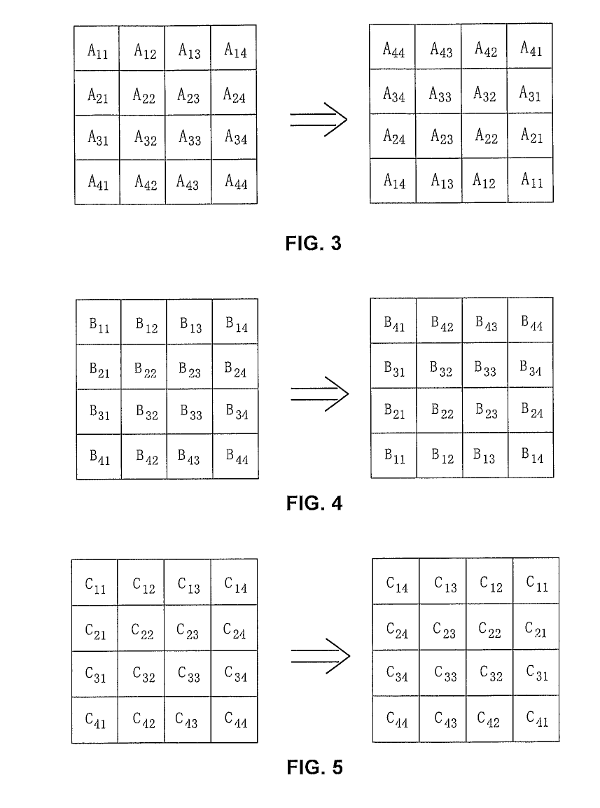

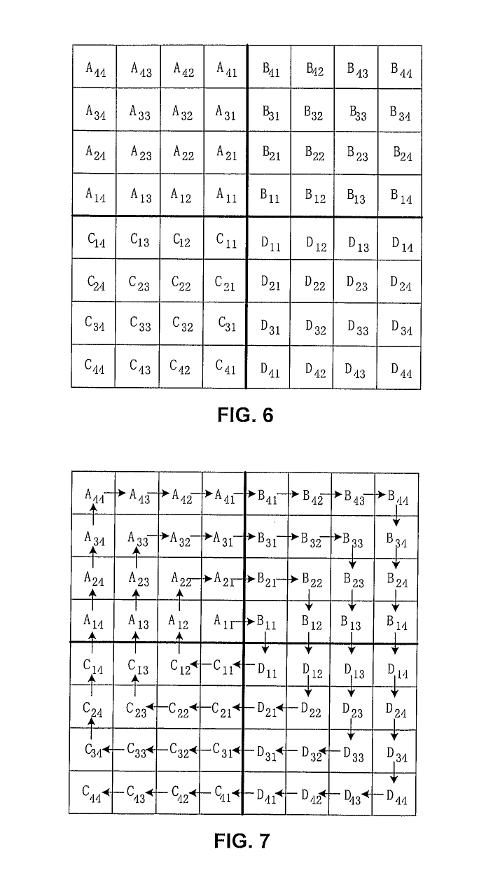

According to a specific embodiment a super-block is made up of four transformed blocks as depicted on FIG. 2: a first transformed block A (up-left block), a second transformed block B (up-right block), a third transformed block C (bottom-left block) and a fourth transformed block D (bottom-right block). On this figure the zig-zag pattern according to the state of art is also depicted. To gather the lowest frequency coefficients of each block in the center of the super-block, blocks A, B, and C are transposed (step 20) while the block D remain unchanged. The transposition of coefficients in block A depicted on FIG. 3 is centro-symmetric. The transposition of coefficients in block B depicted on FIG. 4 consists in exchanging first and fourth rows and in exchanging second and third rows. The transposition of coefficients in block C depicted on FIG. 5 consists in exchanging first and fourth columns and in exchanging second and third columns. After the transposing step 20, the lowest frequency coefficients of the four blocks A, B, C and D are gathered in the center of the super-block while the highest frequency coefficients are located on the outer side of the super-block as depicted on FIG. 6.

According to a preferred embodiment, the coefficients within a super-block are scanned (step 40) according to a spiral scanning pattern from the lowest frequency coefficients to the highest frequency coefficients as depicted on FIGS. 7 to 14. The process is applied separately to the luminance and chrominance blocks.

According to another embodiment the coefficients are not explicitly transposed. The coefficients of FIG. 2, i.e. after the transforming step 10, are scanned within the super-block according to a scanning pattern as the one of FIG. 15 so that the lowest frequency coefficients are scanned first and the highest frequency coefficients are scanned at the end. On this figure, for sake of clarity, numbers are used instead of arrows to indicate the scanning order of the coefficients after the transforming step 10.

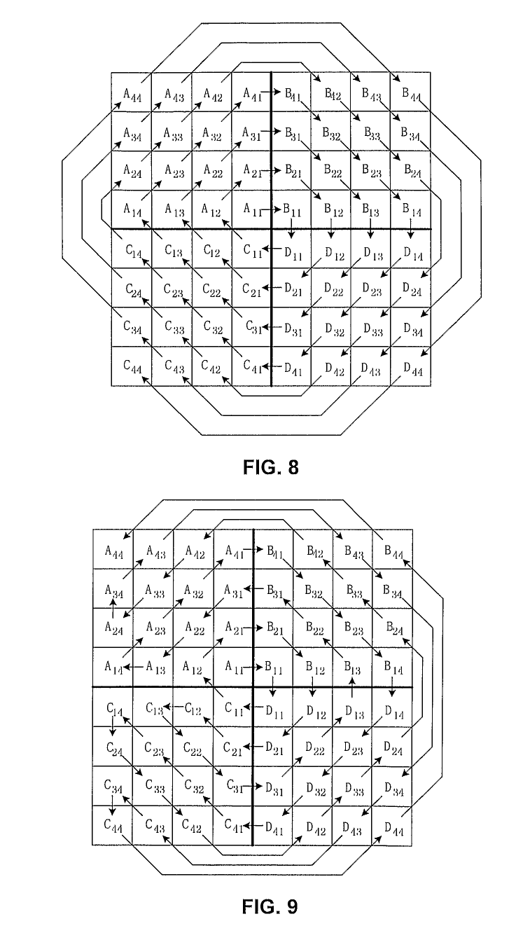

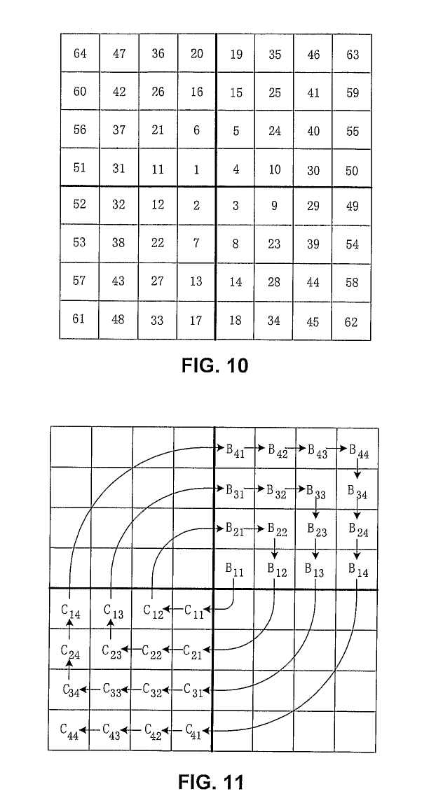

More generally, the invention includes any spiral like scanning patterns covering more than one transformed block starting from the lowest frequency coefficients and ending with the highest frequency coefficients. Therefore, the spiral pattern can turn in the clockwise direction as depicted on FIGS. 7 to 8, can turn in the anti-clockwise direction or partly in the clockwise direction and partly in the anticlockwise direction as depicted on FIG. 9. The scanning pattern can also have a different priority between the vertical and the horizontal direction. For example, the scanning pattern for coding interlace sequence of pictures can put higher priority on the vertical direction in order to improve the coding efficiency since higher correlation exits between coefficient along the horizontal direction as depicted on FIG. 10 where, for sake of clarity, the numbers are used instead of arrows to indicate the scanning order of the coefficients after the transposing step 20. The invention described for block of 4 by 4 pixels may be applied to blocks of 8 by 8 pixels, or even larger blocks. Besides the super-block may also comprise more than 4 blocks. The only constraint is that the super-block is larger than the transformed blocks.

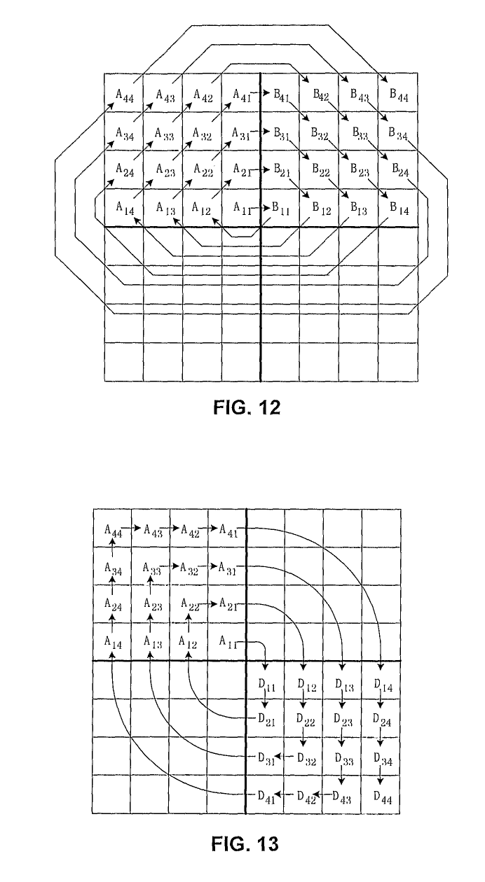

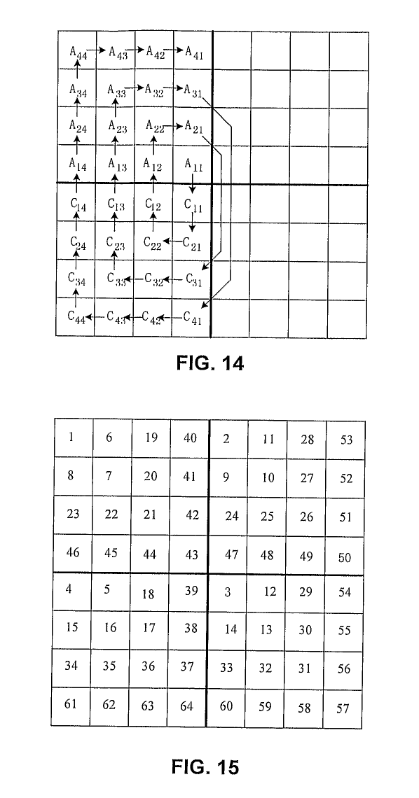

According to another aspect of the invention, the scanning pattern is modified when some of the blocks within the super-block are all-zero blocks, i.e. when all their coefficients equal zero. For example, if transformed blocks A and D are all-zero blocks, then the scanning pattern depicted on FIG. 7 is changed to the scanning pattern depicted on FIG. 11, i.e. the coefficients of blocks A and D are skipped during the scanning step 40. This modified scanning pattern allows saving more bits since the zero coefficients of these two blocks are no longer coded. Another example of modified scanning pattern is depicted on FIG. 12. This modified scanning pattern is advantageously used when transformed blocks C and D are all-zero blocks. FIGS. 13 and 14 depict modified scanning pattern when B and C are all-zero blocks and when B and D are all-zero blocks respectively.

According to a preferred embodiment, the sequence of pictures is encoded using both the transposed transform with the spiral-like scanning pattern and the traditional transform with the traditional scanning pattern, the choice being made at the macroblock, slice, picture or GOP (GOP stands for Group Of Pictures) level. To this aim one or more bits are inserted in the bitstream in order to indicate whether the scanning step 40 is applied to super-blocks larger than the transformed blocks or whether the scanning step 40 is applied to each transformed blocks. More particularly one or more bits is(are) inserted to indicate whether the traditional transform and the scanning pattern are used or if the transposed transform and the scanning pattern according to the invention are used to encode the picture data. This bit(s) is(are) inserted at the macroblock, slice, picture or GOP level and therefore the switching from one transform/scanning solution to the other is performed at the macroblock, slice, picture or GOP level respectively. This choice is done by an encoding device based for example on a rate-distortion criterion.

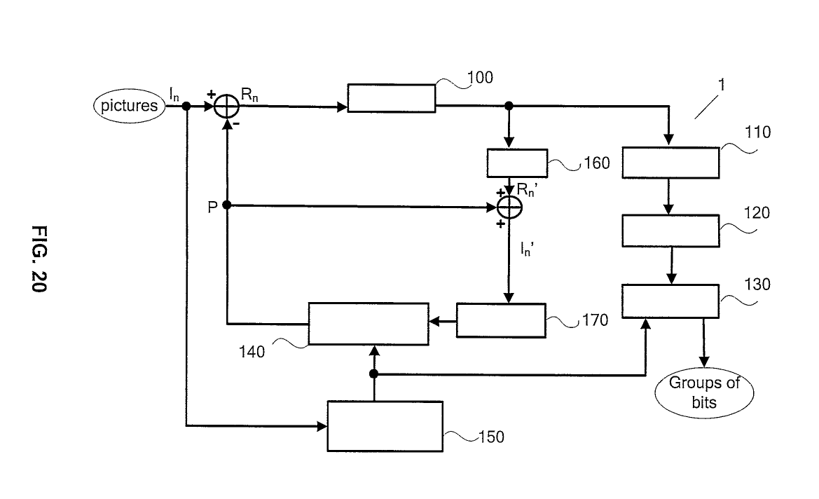

The invention also relates to a decoding method depicted on FIG. 19. This method is adapted to decode a group of bits generated by the encoding method according to the invention. The decoding method comprises the steps of:
decoding 60 at least one group of bits in a set of coefficients in the frequency domain;
rearranging 70 the coefficients in blocks of coefficients by reversing the process of step 40 of the encoding method;
transposing 80 the coefficients in order to reverse the process of the transposing step 20 of the encoding method; and
transforming 100 said blocks of coefficients by applying an inverse transform M⁻¹.

According to another embodiment the decoding method also comprises a step 90 for de-quantizing the coefficients. This step 90 is applied either before the transposing step 80 or after the transposing step 80.

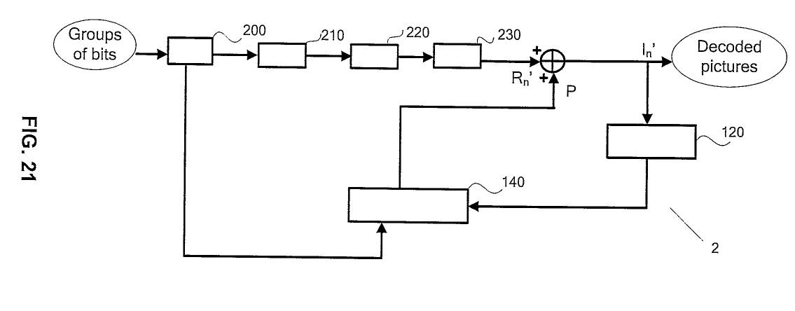

The invention also relates to an encoding device 1 depicted on FIG. 20 that implements the method according to the invention. The coding device comprises:
a module 100 for transforming and possibly quantizing the blocks of pixels in transformed blocks;
a module 110 for transposing the transformed blocks of coefficients;
a module 120 for scanning the coefficients according to the invention;
and a module 130 for entropy coding the scanned coefficients according to the invention.
   The module 110 is not required if the coefficients are not explicitly transposed and are directly scanned according to the scanning pattern of FIG. 15.
   The encoding device may further comprise:
an intra/inter prediction module 140 for computing prediction blocks P used for computing blocks of residuals Rn;
a module 150 for estimating motion vectors, said motion vectors being used by the prediction module 140; and
a module 160 for reconstructing the blocks of residuals R′ₙ, said module performing an inverse transform and possibly dequantizing the coefficients; and
a memory 170 for storing the reconstructed blocks I′ₙ.

The invention relates to a decoding device 2 as depicted on FIG. 21. The decoding device 2 is adapted to decode groups of bits generated by the encoding device 1 and implements the decoding method according to the invention. The decoding device 2 comprises:
a module 200 for decoding a group of bits in a set of coefficients in the frequency domain;
a module 210 for rearranging the coefficients in blocks of coefficients by reversing the process of step 40 of the encoding method; and
a module for transposing 220 the coefficients in order to reverse the process of the transposing step 20 of the encoding method;
a module 230 for transforming said blocks of coefficients by applying an inverse transform M⁻¹ and possibly for de-quantizing the coefficients.

In FIGS. 20 and 21, the modules represented are functional units, which may or may not correspond to physically distinguishable units. For example, these modules or some of them may be grouped together in a single component, or constitute functionalities of one and the same software. A contrario, certain modules may possibly be composed of separate physical entities.

1. Method for encoding a plurality of non overlapping blocks in a picture, comprising the steps of:
transforming each of said blocks into a transformed block of coefficients in the frequency domain by applying a predefined transform;
scanning said coefficients across at least two neighboring transformed blocks from the lowest frequency to the highest frequency according to a predefined scanning pattern, said group of at least two neighboring transformed blocks being called super-block; and
entropy coding said scanned coefficients of said super-block into an entropy coded group of bits.

2. Method according to claim 1, wherein the predefined transform applied to each block of said super-block is such that the lowest frequency coefficients are located in the center of the super-block while the highest frequency coefficients are located on the outer side of said super-block.

3. Method according to claim 1, wherein the same predefined transform is applied to each block of said super-block and wherein the transforming step is followed by a transposing step for rearranging the coefficients within said super-block so that the lowest frequency coefficients are located in the center of said super-block while the highest frequency coefficients are located on the outer side of said super-block.

4. Method according to claim 2, wherein the scanning pattern is a spiral pattern.

5. (canceled)

6. Method according to claim 1, wherein said super-block is made up of two lines of two blocks.

7. Device for encoding a sequence of pictures divided into non overlapping blocks comprising:
means for transforming each of said blocks into a transformed block of coefficients in the frequency domain by applying a predefined transform;
means for scanning said coefficients; and
entropy coding means for encoding said scanned coefficients into an entropy coded group of bits;
scanning means are adapted to scan the coefficients across at least two neighboring transformed blocks from the lowest frequency to the highest frequency according to a predefined scanning pattern.

8. Bitstream of MPEG type wherein said bitstream comprises at least one bit indicating whether the size of the predefined scanning pattern used for the encoding of at least a portion of an image is larger than the size of a transformed block or whether said size of the predefined scanning pattern equals the size of the transformed block.

9. Bitstream of MPEG type wherein said bitstream comprises at least one bit indicating whether the size of the predefined scanning pattern used for the encoding of a group of images is larger than the size of a transformed block or whether said size of the predefined scanning pattern equals the size of the transformed block.

10. Method for decoding at least one group of bits representative of a plurality of non overlapping blocks in a picture, comprising the steps of:
entropy decoding said at least one group of bits into a set of coefficients in the frequency domain;
rearranging said coefficients in at least two neighboring blocks of coefficients according to a predefined scanning pattern covering said at least two neighboring blocks;
transforming each of said blocks of coefficients into a block of image data by applying a predefined transform.

11. Method according to claim 10, wherein the transforming step is preceded by a transposing step for rearranging the coefficients within each of said blocks so that the lowest frequency coefficients are located top left of said block while the highest frequency coefficients are located bottom right of said block.

12. Device for decoding at least one group of bits representative of a plurality of non overlapping blocks in a picture, comprising:
means for entropy decoding said at least one group of bits into a set of coefficients in the frequency domain;
means for rearranging said coefficients in at least two neighboring blocks of coefficients according to a predefined scanning pattern covering said at least two neighboring blocks;
means for transforming each of said blocks of coefficients into a block of image data by applying a predefined transform.

13. Device according to claim 12, further comprising means for rearranging the coefficients within each of said blocks so that the lowest frequency coefficients are located top left of said block while the highest frequency coefficients are located bottom right of said block.
